(19) United States
(12) Patent Application Publication
(10) Pub. No.: US 2022/0136889 A1
(43) Pub. Date: May 5, 2022

(54) Real-Time Commercial Vehicle Weight Measurement and Use

(71) Applicant: Robert Bosch GmbH, Stuttgart (DE)

(72) Inventor: Steven Zack, Essex, CT (US)

(21) Appl. No.: 17/085,130

(22) Filed: Oct. 30, 2020

(51) Int. Cl. G01G 19/12; B60G 17/017; B60G 17/0185

(52) U.S. Cl. CPC G01G 19/12; B60G 17/017; B60G 2300/026; B60G 2400/61; B60G 17/0185

(57) ABSTRACT

A real-time commercial vehicle weight loading system is disclosed. The system employs a number of vehicle weight sensors, configured to provide vehicle weight data for a respective zone of the vehicle. The system may also utilize at least one cargo weight sensor to provide weight data of not-yet loaded cargo. A system controller is in communication with the weight sensors and is configured to, upon receiving cargo to be loaded information, send an indication of optimal cargo placement including identifying the cargo to be loaded, the location on the vehicle the cargo is to be loaded, and monitoring the loading of the vehicle. This same system may also provide total vehicle weight and broadcast real-time vehicle weights when pinged by a query device, which will allow for uninterrupted transit of the vehicle and cargo. This system may also provide data for improved vehicle stability.

### TECHNICAL FIELD

This disclosure relates to real-time, on-vehicle, verifiable cargo weight load and balance measurement and a system to optimize cargo placement on the vehicle.

### BACKGROUND

A truck or lorry is a motor vehicle designed to transport or tow cargo or freight, usually without a trailer. The term commercial truck is usually applied to a large and powerful vehicles that may also be configured to be mounted with specialized equipment, such as in the case of garbage trucks, fire trucks, concrete mixers, and suction excavators. In American English, a commercial vehicle without a trailer or other articulation is sometimes referred to as a straight truck while one designed specifically to pull a trailer is not a truck but a tractor. In the European Union, vehicles with a gross combination mass of up to 3.5 t (7,700 lb) are known as light commercial vehicles, and those over as large goods vehicles.

A semi-tractor-trailer truck is the combination of a tractor unit and one, or more, semi-trailers to carry and transport cargo or freight. A semi-trailer attaches to the tractor with a type of hitch called a fifth-wheel. It is variously known as a transport truck, semi-trailer truck, tractor-trailer truck, semi-tractor truck, semi-truck, trailer truck, tractor truck, transfer truck, articulated truck, artic, single truck, semi-tractor-trailer, semi-trailer, tractor-trailer, semi-tractor, semi, trailer, tractor, big rig, eighteen-wheeler and articulated lorry, depending on the country and region.

These vehicles will be referred to as trucks or commercial vehicles, even if personally owned/operated or privately utilized, and, of course, all such vehicles have a vehicle weight, a cargo weight, and a combined weight. Knowing the weight of trucks is important for many reasons, such as monitoring and research of vehicle weights for pavement design, bridge capacities, and vehicle safety capabilities.

A weigh station is a checkpoint along a highway used to inspect commercial vehicle weights. Weigh stations are typically equipped with external truck scales, some of which are weigh-in-motion and permit the trucks to continue moving at a slower speed while being weighed, while static scales require the trucks to stop all together. There are many different external scales used, from single axle scales to multi-axle sets. It is generally agreed that the accuracy of weigh-in-motion data is less than for static weigh scales where the environment is better controlled. The European COST 323 group developed an accuracy classification framework in the 1990s and coordinated three independently controlled road tests of weigh-in-motion systems (still utilizing external scales), in Switzerland, France, and Northern Sweden. Better accuracy was found to be achieved with multiple-sensor weigh-in-motion systems and careful compensation for the effects of temperature, however static scales where still found to be better.

Weigh stations can provide valuable safety information to ensure vehicles are not overloaded, and they can extend road life by ensuring that vehicle axle or wheel weights are kept below a certain threshold for the road surface. The U.S. federal maximum weight is set at 80,000 pounds, without an overweight permit, but individual States may also regulate differently. If a truck is found to be overweight, the vehicle may be ordered to stop until the situation can be resolved. In some cases, if the vehicle has a weight rating high enough that it may be safe to proceed, the driver may receive an overweight ticket or apply for an overweight permit. In other cases the extra freight may have to be offloaded before the vehicle can continue. Offloading the extra freight may not be practical for perishable or hazardous loads, and the time it takes to offload even some of the cargo may impact all of the freight from reaching its intended destination on schedule. In any case, current weigh stations restrict flow of scheduled freight and truckers often refer to weigh stations as chicken coops.

Some States have recently started using electronic bypass systems (or AVI—Automatic Vehicle Identification) to alleviate some of the truck traffic through the weigh station. Some of the best known are PrePass, NORPASS and Drivewyze. The systems may consist of equipment at the weigh station itself, as well as a truck mounted transponder or smartphone, usually placed on the inside of the windshield or on the dashboard. These may be similar to transponders used for toll collection. Each transponder is directly registered to a specific truck, and contains a unique identification. The registration process propagates information such as carrier name, unit number, and elected gross weight to weigh stations.

As a truck approaches a weigh station, an electronic reader on a boom over the freeway reads the information from the truck transponder. In this system there are often weight detecting devices in the roadway itself, however these scale like devices are not as accurate as traditional stop and measure scales or the weigh-in-motion scales mentioned above. The trucks may also self-certify their weight by a scale measurement at their loading facility, but with no verification opportunity short of stopping the vehicle to check. The system may automatically determine if a truck needs to stop to verify or take a more accurate reading. If the safety information is acceptable the truck may receive a green light and can continue without entering the weigh station at all. However, a driver may get a red light, and on these occasions, the truck must pull into the weigh station for the normal weigh-in procedure. The most common reason found on a redlighted truck is a weight problem.

Thus current weigh stations, although providing needed safety and compliance checks, slow down the transportation of goods around our country and add to inefficiencies, delay, and extra costs.

A few on-vehicle commercial vehicle weight measurement systems, as opposed to using external scales, have been developed. One system for determining the weight of a truck may use the self-leveling capability of air suspension systems, if so equipped, to calculate weight at the axles. An Air-Weigh system has a kit including an external scale and a pressure sensor assembly. The pressure sensor is installed in the air suspension line, and by calibrating and measuring the suspension air pressure in reference to the external scales, the “Air-Weigh” system can be used to estimate the weight. After calibrating, the system sends pressure and temperature information to a handheld receiver, however these systems have been found to be less accurate at varying temperatures.

Another on-vehicle commercial vehicle weight measurement system may be reviewed in U.S. Patent Application 2007/0181350 to Kranz et al. Kranz et al. discloses a system for measuring weight on a trailer of a commercial vehicle using a system having a plurality of sensors, wherein each sensor is attached to an axle of the trailer or the vehicle. A microcontroller receives a transmission of strain change from each sensor. A display unit displays a calculated weight on the trailer from the microcontroller. The same document also discloses a method for measuring weight on a trailer of a vehicle comprising the steps of measuring the strain at two or more locations on the vehicle, determining a strain difference since a previous tare cycle, calculating the bending moment, and displaying on a display unit an estimated weight on the trailer.

Other onboard load weighing systems for vehicles utilize load cells between the hopper rails and the vehicle's chassis. Or systems that describe the installation of load cells or strain gauges on the springs and/or vehicle axles, with an indicator that informs the weight per axle, or net weight and total weight of the vehicle load. There are also, systems that describe the use of a laser or ultrasonic sensor for the height variation measurement, usually installed on the suspension springs of the vehicle. Or the use of an inclinometer fixed to the suspension springs of the vehicle. U.S. Patent Application 2017/0254694 to Toigo discloses rectilinear displacement transducers with inductive or resistive effect sensors fixed to the suspension and the vehicle's chassis to provide weights at each axle side or wheel. Thus is can be concluded that blowing cargo weight is desirable, but none of these systems directly address the preventing of inefficiencies in the transportation of goods or how to prevent overloading or improve vehicle safety/stability.

Accordingly, an on-vehicle, real-time, verifiable method of measuring a truck weight and providing wirelessly the gross vehicle weight transmitted to the weigh stations ensuring the vehicle weight load restriction is in legal compliance with local and national weight restrictions while allowing the commercial vehicle to not have to stop during transit is desirable. Additionally an on-vehicle, real-time, verifiable method of measuring a truck weight at each axle corner or wheel, and communicating this information with the vehicle's stability control system, or anti-lock braking system, could provide for safer vehicle operation while cornering and braking, especially if the cargo shifts or is loaded/unloaded at varying intervals/locations. And ultimately a system that monitors cargo placement on to the truck real time and coordinates cargo location for optimal loading is needed and thus disclosed here.

### SUMMARY

One aspect of this disclosure is directed to a commercial vehicle weight system having first and second vehicle sensors located on a vehicle offset from from each other, with each vehicle sensor configured to sense a physical change of a location on the vehicle and send a first and second vehicle weight signal. In this system, a controller is configured to, upon receiving the first and second vehicle weight signals, send an indication of optimal cargo placement.

The vehicle defines a longitudinal axis extending substantially down a center of the vehicle fore and aft, and the first and second sensors may be located on opposite sides of the longitudinal axis of the vehicle. The vehicle further defines a number of transverse axes that run substantially orthogonal to the longitudinal axis, and the vehicle sensors may be located substantially along one transverse axis of the vehicle.

This system may also include third and fourth vehicle sensors, also located on the vehicle, and also offset from each other vehicle sensor. The third and fourth vehicle sensors are also configured to sense physical changes of their locations on the vehicle and send a third and fourth vehicle weight signals. Some of the vehicle sensors may be offset from each other on opposite sides of the longitudinal axis of the vehicle, and other vehicle sensors may be offset from each other fore and aft on the vehicle.

This system may also include a cargo weight sensor. This weight sensor is ideally located on a cargo loader and configured to measure and send a cargo weight signal. Including this additional weight signal with the others, the controller may be further programmed to send an enhanced indication of optimal cargo placement and monitor the selection and loading of cargo real-time. This system may also employ a memory storage device in communication with the controller. The memory may contain weight information of a number of cargo not yet loaded on the vehicle. Having this additional information allows the controller send yet a more enhanced indication of optimal cargo placement.

This system may also utilize two controllers. A two controller system could have a first controller located near cargo not yet loaded on the vehicle, and a second controller located on the vehicle. The two controllers may communicate with each other and work in conjunction to send the indication of optimal cargo placement. The indication of optimal cargo placement may include identifying specific cargo to be loaded, verifying the weight of the cargo to be loaded, indicating the location on the vehicle for the cargo to be loaded, and verifying the cargo was loaded in the indicated location.

This system may also employ a transceiver unit, or a receiver/transmitter unit located on the vehicle. A transceiver unit could allow for external communication with the controller. Additionally the controller may then, utilizing received weight signals and aggregating to a vehicle weight, broadcast the vehicle weight through the transceiver.

The controller is located on the vehicle and in continued communication with the weight sensors, and the controller is further programmed to, upon receiving a request, broadcast thru the transceiver real-time vehicle weight information. When at least one controller is located on the vehicle, it may monitor changes in weight signals from the weight sensors. The controller may also be programmed to, upon receiving a change in vehicle weight signals above a threshold while the vehicle is in motion, send an indication of a shifted load. A threshold value of a change or delta in weight may need to be set to account for minor wieght shifting and suspension bounce during normal driving conditions. If all weight sensors experience similar changes at the same time, then it is likely just movement of the vehicle. However, if one weight sensor sends an indication of a large loss of weight, while another weight sensor sends an indication of a corresponding weight increase, it may be an indication of a shifted load on the vehicle. Sending information of a shifted load to the driver may help to ensure the safety of the driver in numerous ways.

The controller may be capable of communication with a stability control system of the vehicle, and then the controller may forward the vehicle weight signals, and the locations of the sensors, to the stability control system. The stability control program, once having this data may brake the vehicle different, such as by modifying brake pressures at different wheels to help balance the shift in the load, or said another way, to help maintain stability with a shifted load. It also may be as simple as providing an indication of a shifted load to a driver of a boxed in cargo container to give them a ‘head-up’ before opening a door on a possibly shifted load of cargo that could come toppling out.

This system may employ strain gauges located on axle components of the vehicle. The vehicle sensors may send their respective vehicle weight signals wirelessly.

Another aspect of this disclosure is directed to a real-time commercial vehicle weight loading system. In this aspect, a number of vehicle weight sensors are located on a vehicle, each configured to provide vehicle weight data for a zone of the vehicle. Additionally employed in this aspect is at least one cargo weight sensor configured to provide weight data of not-yet loaded, or as loaded, cargo. In this aspect, a controller is in communication with all the weight sensors and is programmed to upon receiving cargo to be loaded information, send an indication of optimal cargo placement. The optimal cargo placement includes identifying the cargo to be loaded, the location on the vehicle the cargo is to be loaded, and monitoring the loading of the vehicle.

In this system, at least one of either the loading weight sensor, or number of vehicle weight sensors, is further configured to provide off-boarding weight data of cargo removed at differing time intervals. This allows the controller to receiving the off-boarding weight data and re-optimize the placement of remaining cargo. However, when the cargo placement is not able to be re-optimized, the controller is configured to send weight balance data to an electronic stability control system of the vehicle. This aspect also includes utilizing the controller to aggregate loaded cargo with a baseline vehicle weight and send a signal of total vehicle weight. This system improves balance of the cargo, handling of the vehicle, and provides an efficient way to give total vehicle weight to municipalities.

A further aspect of this disclosure is directed to a vehicular weight infrastructure. In the infrastructure aspect, the system has a number of vehicle weight sensors each configured to be located on a vehicle and provide real-time data of a sprung mass of the vehicle. In this aspect, a controller is configured to be located on the vehicle and, upon receiving the real-time data of the sprung mass of the vehicle, as well as having a base-line weight of an unloaded vehicle, compute a total vehicle weight.

This system provides a transceiver configured to be located on the vehicle and also configured to be communicable with the controller. This system also provides for a query device, located outside of the vehicle, configured to send a pinging signal near the vehicle, such that the transceiver receives it and in conjunction with the controller in response broadcasts the total vehicle weight. In this aspect, the query device may be located adjacent or overhead of a roadway. It may also comprises a proximity sensor to trigger the pinging signal, such that when a truck goes by (or comes within proximity), then the pinging signal is sent. This system may also employ a static scale in communication with the controller. The static scale may be used to provide a base-line weight of an unloaded vehicle. The static scale may be located at the loading center or at a point in time before cargo is loaded, when timeliness of the vehicle or the cargo to be transported is less critical.

The above aspects of this disclosure and other aspects will be explained in greater detail below with reference to the attached drawings.

### BRIEF DESCRIPTION OF THE DRAWINGS

FIG. 1 is a side-view diagrammatic illustration of a truck at a loading dock.

FIG. 2 is an underside diagrammatic illustration of the truck.

FIG. 3 is an overhead diagrammatic illustration of cargo placement with a vehicle.

FIG. 4 is a diagrammatic illustration of a truck utilizing the teachings herein to bypass a weigh station.

FIG. 5 is a overhead diagrammatic illustration of a number of trucks at a loading dock.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

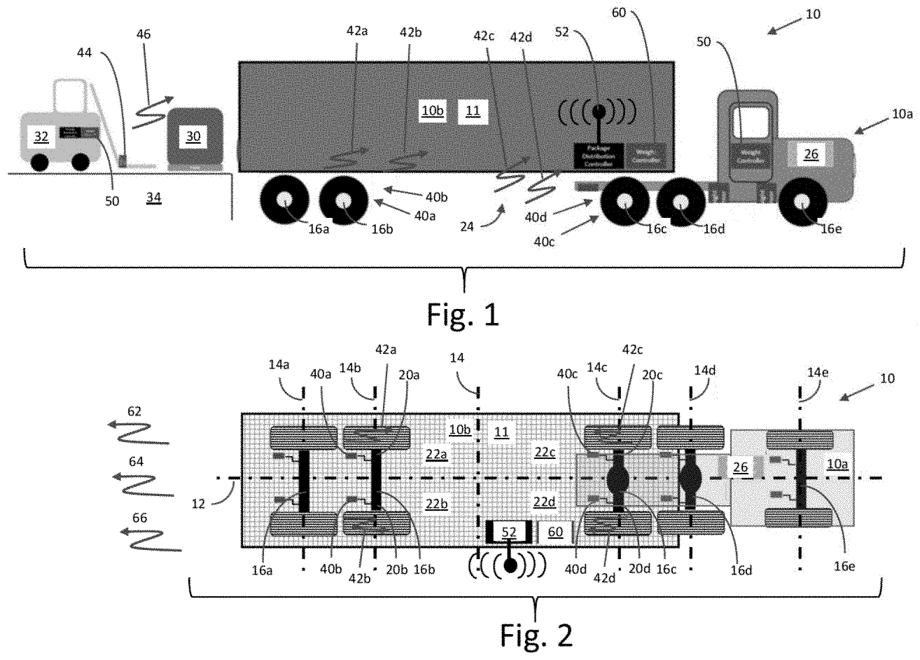

FIGS. 1 and 2 show a vehicle 10. Vehicle 10 may be referred to as a commercial vehicle, a truck, or any number of other names as described above, having a cargo area 11. Vehicle 10 is shown here having a tractor 10a and a separatable/articulating trailer 10b, with the trailer 10b being the cargo area 11, however vehicle 10 may be a vehicle suitable for transporting cargo without a trailer. In other words, the cargo area 11 of the vehicle 10 may be directly attached to the main body of the vehicle, such as in the case of a box truck or van, for example. Vehicle 10 has a longitudinal axis 12 extending substantially down a center of the vehicle fore and aft (see FIG. 2). Additionally, vehicle 10 has a number of transverse axes 14 running orthogonal to the longitudinal axis (see also FIG. 2).

Vehicle 10 has a number of axles 16 that extend across a portion of the vehicle. Each axle 16 extends substantially parallel to one transverse axis 14. Substantially, as used here, means within +/−15 degrees. In FIG. 2, five axles 16a, 16b, 16c, 16d, 16e are shown running substantially parallel to five transverse axes 14a, 14b, 14c, 14d, 14e. However, a vehicle may have as little as two axles, and in the case of needing to transport very heavy loads, many, many more. Axles 10 may be a solid axle design, or may be a theoretical line between two independently sprung wheels, in the case of an independent suspension design. Axles 16, whether solid or theoretical lines, are made up of axle components 16, and in this case for simplicity, axle components will also include suspension components.

For sake of defining specific portions of vehicle 10 for use in spatial relationships later in this document, we define a first location 20a, a second location 20b, a third location 20c, and a fourth location 20d. The locations 20 may be on the axle, axle components, or suspension 16, or may be in the cargo area 11, such as on the floor of the cargo area. We also identify a number of zones 22a, 22b, 22c, 22d somewhat correlating the locations 20a, 20b, 20c, 20d (see FIG. 2).

Vehicle 10 has a sprung mass 24 (see FIG. 1). Sprung mass 24, or sprung weight 24, in a vehicle with a suspension, is the portion of the vehicle's total mass that is supported by the suspension. The sprung mass typically includes the body, frame, the internal components, passengers, and cargo, but does not include the mass of the components at the other end of the suspension components such as the wheels, wheel bearings, brake rotors, calipers, and/or continuous tracks (also called caterpillar tracks), if any, which are part of the vehicle's unsprung mass. The total vehicle weight is the sprung mass plus the unsprung mass.

Vehicle 10 may also have a stability control system 26, such as electronic stability control (ESC), electronic stability program (ESP), dynamic stability control (DSC), or an anti-lock braking system (ABS). When ESC detects loss of steering control, it automatically applies the brakes to help steer the vehicle where the driver intends to go. Braking is automatically applied to wheels individually, such as the outer front wheel to counter oversteer, or the inner rear wheel to counter understeer. Some ESC systems also reduce engine power until control is regained. ABS operates by preventing the wheels from locking up during braking, thereby maintaining tractive contact with the road surface and allowing the driver to maintain more control over the vehicle.

FIG. 1 also shows cargo 30 and a cargo loader 32 on a loading dock 34, outside of the vehicle 10, as soon to be loaded cargo into the cargo area 11.

A first vehicle sensor 40a is located on the vehicle 10, shown here at the first location 20a. The first vehicle sensor 40a is configured to sense a first physical change of the first location 20a, and then further configured to send a first vehicle weight signal 42a. Vehicle weight signal 42a may be sent by a physically connected cable or wirelessly. Vehicle sensor 40a may be strain gauge located on an axle component 16 of the vehicle 10.

A second vehicle sensor 40b is located on vehicle 10, shown here at the second location 20b. The second vehicle sensor 40b is offset from the first vehicle sensor 40a. Offset, as used here, means not in the same location and spaced far enough apart, or on separate vehicle componentry to provide useful measurement data for the system. Ideally, first and second sensors 40a, 40b may be located on opposite sides of the longitudinal axis 12 of the vehicle 10, or said another way, first and second vehicle sensors 40a, 40b are offset from each other on opposite sides of a longitudinal axis 12 of the vehicle 10. The first and second vehicle sensors 40a, 40b may be located substantially along a transverse axis, shown here as 14b, of the vehicle 10.

The second vehicle sensor 40b is configured to sense a second physical change of the second location 20b of vehicle 10. Then, also, the second vehicle sensor 40b is configured to send a second vehicle weight signal 42b. Vehicle weight signal 42b may be sent by a physically connected cable or wirelessly. Vehicle sensor 40b may also be a strain gauge located on an axle component 16 of the vehicle 10.

A third vehicle sensor 40c is located on vehicle 10, shown here at the second location 20c. The third vehicle sensor 40c is located on the vehicle offset from the first and second vehicle sensors 40a, 40b. The first and third vehicle sensors 40a, 40c may be offset from each other fore and aft on vehicle 10. The third vehicle sensor 40c is configured to sense a third physical change of the third location 20c of vehicle 10. The third vehicle sensor is then similarly configured to send a third vehicle weight signal 42c. Vehicle weight signal 42c may also be sent by a physically connected cable or wirelessly. Vehicle sensor 40b may also be a strain gauge located on an axle component 16 of the vehicle 10.

A fourth vehicle sensor 40d is located on vehicle 10, shown here at the fourth location 20d. The fourth vehicle sensor 40d is located on the vehicle offset from the first, second, and third vehicle sensors 40a, 40b, 40c. The third and fourth vehicle sensors 40c, 40d are offset from each other on opposite sides of a longitudinal axis 12 of vehicle 10. The second and fourth vehicle sensors 40b, 40d are offset from each other fore and aft on vehicle 10. The fourth vehicle sensor 40d is configured to sense a fourth physical change of the fourth location 20d of vehicle 10. And like the rest, the fourth vehicle sensor 40d is configured to send a fourth vehicle weight signal 42d. Vehicle weight signal 42d may be sent by a physically connected cable or wirelessly. Vehicle sensor 40d may also be a strain gauge located on an axle component 16 of the vehicle 10.

Although four vehicle sensors 40a, 40b, 40c, 40d are shown in FIGS. 1 and 2, it should be understood that a number of vehicle sensors 40 may be configured to be located on vehicle 10 in varying locations. These vehicle sensors 40 are configured to provide vehicle weight data 42 for a respective zone 22 of the vehicle. As seen in FIG. 2, vehicle sensor 40a could provide weight data 42 for a first zone 22a, vehicle sensor 40b could provide weight data 42 for a second zone 22b, and so on and so forth. Vehicle sensors 40 may be configured to provide real-time data of the sprung mass of the vehicle.

FIG. 1 also shows a cargo weight sensor 44. Cargo weight sensor 44 may be located on the cargo loader 32 and is configured to measure (weigh) cargo 30 at the loading dock 34, or warehouse, or as it is being loaded on or off-loaded from the vehicle 10. Cargo weight sensor 44 is configured to send a cargo weight signal 46. Cargo weight sensor 44 may be located on forks of a fork-lift 32, as depicted here, or could be a traditional scale that cargo is placed upon, or in the line or hook of a crane. The intent of cargo weight sensor 44 is to provide weight data of not-yet loaded, or as loaded, cargo 30.

A memory storage device 50 may be used to store information such as weight information of a number of cargo 30 not yet loaded on the vehicle. There may be multiple memory storages 50, located on or off vehicle. A memory storage device 50 located on vehicle may also contain data such as an empty weight of vehicle 10.

A transceiver unit/transceiver 52 may also be located on vehicle 10. The transceiver is configured to both receive information/signals and to broadcast information/signals.

A controller 60 may be located on the vehicle 10 and configured to, upon receiving the first and second vehicle weight signals 42a, 42b, send an indication of optimal cargo placement 62. The controller 60 may also be further configured to, upon receiving the cargo weight signal 46, send the indication of optimal cargo placement 62. The controller 60 may be in communication with the Memory storage 50, and further configured to, upon receiving information about the numbers of cargo to be loaded on the vehicle, send the indication of optimal cargo placement 62.

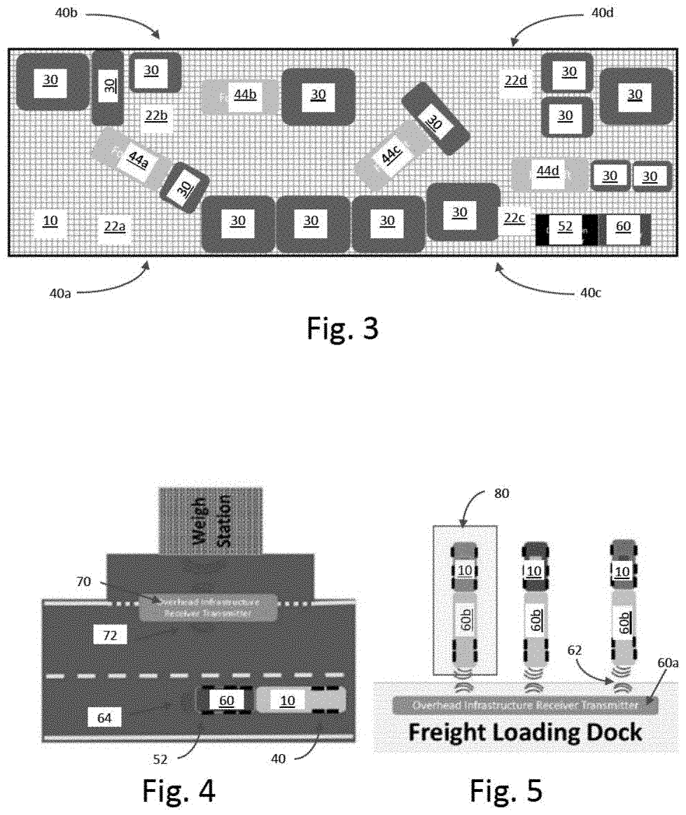

FIG. 3 shows the controller 60 is in communication with the weight sensors (vehicle weight sensors 40a, 40b, 40c, 40d and cargo weight sensors 44a, 44b, 44c, 44d) and is configured to, upon receiving cargo to be loaded information, send an indication of optimal cargo placement including: identifying the cargo 30 to be loaded, the location on the vehicle the cargo is to be loaded, e.g. 22a, 22b, 22c, 22d, and monitoring the loading of the vehicle 10. Alternatively, at least one of either the cargo weight sensor 44, or number of vehicle weight sensors 40, is further configured to provide off-boarding weight data 42 or 46 of cargo 30 removed at differing time intervals, and the controller 60 is then further configured to, upon receiving the off-boarding weight data 42 or 46, re-optimize the placement of remaining cargo 62. Following this, when the cargo 30 placement is not able to be re-optimized in the vehicle, then the controller 60 is configured to send weight balance data to an electronic stability control system 26 of the vehicle 10 (see FIG. 2).

Referring now to FIG. 4, the controller 60 may also be configured to, utilizing received weight signals 40, 46 (see FIGS. 1 and 3), aggregate a total vehicle weight. The controller 60 may also aggregate loaded cargo with a baseline vehicle weight and send a signal of total vehicle weight 64. The controller 60 when configured to be located on the vehicle 10, upon receiving the real-time data of the sprung mass 24 (see FIG. 1) of the vehicle 10, and a base-line weight of an unloaded vehicle, provide upon query a total vehicle weight.

A query device 70 is configured to be located outside of the vehicle 10, and configured to send a pinging signal 72 near the vehicle, such that the transceiver 52 (see FIGS. 1 and 2) in conjunction with the controller 60 receives the pining signal and broadcasts the total vehicle weight 64. The query device 70 may be located adjacent or overhead of a roadway. The query device 70 may utilize a proximity sensor to trigger the pinging signal 72

The controller 60 is ideally configured to utilize the transceiver unit 52 to broadcast the vehicle weight. Ideally, as an example, the controller 60 is located on the vehicle 10 and is in continued communication with the weight sensors 40, such that upon receiving a request, the controller 60 may broadcast thru the transceiver 52 real-time vehicle weight information 64.

The controller 60 when located on the vehicle 10 may also be configured to, upon receiving a change in vehicle weight signals 42, above a threshold (to filter out noise of vehicle bounce) while the vehicle 10 is in motion, send an indication of a shifted load 66. In this scenario, the controller 60 may be capable of communicating with the stability control system 26 of the vehicle 10, and forward the vehicle weight signals 42 to the stability control system 26.

In FIG. 5, the controller 60 is shown as two, or more, controllers consisting of a first controller 60a located near cargo not yet loaded on the vehicle(s) 10 and a second controller 60b, or set of controllers 60b, located on the vehicle(s) 10. The first and second controllers 60a, 60b are capable of communicating with each other and working in conjunction to send indications of optimal cargo placement 62 by identifying specific cargo to be loaded, verifying the weight of the cargo to be loaded, indicating the location on a vehicle 10, or a set of vehicles 10, for the cargo to be loaded, and verifying the cargo was loaded in the indicated location.

A static scale 80 may also be employed. The static scale 80 may be in communication with the controller(s) 60a, 60b and could provide a base-line weight of an unloaded vehicle, or be used to verify proper functioning/calibration of the vehicle sensors 40 as the vehicle 10 is being loaded.

These components and teachings, in varying combination, may be utilized to provide, among other things, a commercial vehicle weight system, a real-time commercial vehicle weight loading system, and a vehicular weight infrastructure.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A commercial vehicle weight system, comprising:
a first vehicle sensor located on a vehicle and configured to sense a first physical change of a first location of the vehicle and send a first vehicle weight signal;
a second vehicle sensor located on the vehicle offset from the first vehicle sensor and configured to sense a second physical change of a second location of the vehicle and send a second vehicle weight signal; and
a controller configured to, upon receiving the first and second vehicle weight signals, send an indication of optimal cargo placement.

2. The system of claim 1, wherein the vehicle defines a longitudinal axis extending substantially down a center of the vehicle fore and aft; and
wherein the first and second sensors are located on opposite sides of the longitudinal axis of the vehicle.

3. The system of claim 2, wherein the vehicle further defines a number of transverse axes that run substantially orthogonal to the longitudinal axis; and
wherein the first and second vehicle sensors are located substantially along a transverse axis of the vehicle.

4. The system of claim 1, further comprising:
a third vehicle sensor located on the vehicle offset from the first and second vehicle sensors, the third vehicle sensor configured to sense a third physical change of a third location of the vehicle and send a third vehicle weight signal; and
a fourth vehicle sensor located on the vehicle offset from the first, second, and third vehicle sensors, and configured to sense a fourth physical change of a fourth location of the vehicle and send a fourth vehicle weight signal;
wherein the first and second vehicle sensors, and the third and fourth vehicle sensors, respectively, are offset from each other on opposite sides of a longitudinal axis of the vehicle, and the first and third vehicle sensors, and the second and fourth vehicle sensors, respectively, are offset from each other fore and aft on the vehicle.

5. The system of claim 1, further comprising a cargo, weight sensor located on a cargo loader and configured to measure and send a cargo weight signal; and
wherein the controller is further configured to upon receiving the cargo weight signal, send the indication of optimal cargo placement.

6. The system of claim 5, further comprising a memory storage in communication with the controller, wherein the memory contains weight information of a number of cargo not yet loaded on the vehicle, and the controller is further configured to, upon receiving information about the numbers of cargo to be loaded on the vehicle, send the indication of optimal cargo placement.

7. The system of claim 1, wherein the controller is two controllers consisting of a first controller located near cargo not yet loaded on the vehicle, and a second controller located on the vehicle in communication with the first controller, and the first and second controllers work in conjunction to send the indication of optimal cargo placement by identifying specific cargo to be loaded, verifying the weight of the cargo to be loaded, indicating the location on the vehicle for the cargo to be loaded, and verifying the cargo was loaded in the indicated location.

8. The system of claim 1, further comprising:
a transceiver unit located on the vehicle capable of communicating with the controller at least once; and
wherein the controller is further configured to, utilizing received weight signals, aggregate a vehicle weight, and the transceiver unit is configured to broadcast the vehicle weight.

9. The system of claim 8, wherein the controller is located on the vehicle and in continued communication with the vehicle sensors, and the controller is further configured to, upon receiving a request, broadcast thru the transceiver real-time vehicle weight information.

10. The system of claim 1, wherein the controller is located on the vehicle and configured to, upon receiving a change in vehicle weight signals above a threshold while the vehicle is in motion, send an indication of a shifted load.

11. The system of claim 1, wherein the controller is capable of communication with a stability control system of the vehicle, and the controller is configured to forward the vehicle weight signals to the stability control system.

12. The system of claim 1, wherein the vehicle sensors are strain gauges located on axle components of the vehicle.

13. The system of claim 1, wherein the vehicle sensors send their respective vehicle weight signals wirelessly.

14. A real-time commercial vehicle weight loading system, comprising:
a number of vehicle weight sensors, each located on a vehicle and configured to provide vehicle weight data for a respective zone of the vehicle;
at least one cargo weight sensor configured to provide weight data of not-yet loaded, or as loaded, cargo; and
a controller in communication with the weight sensors configured to, upon receiving cargo to be loaded information, send an indication of optimal cargo placement including identifying the cargo to be loaded, the location on the vehicle the cargo is to be loaded, and monitoring the loading of the vehicle.

15. The loading system of claim 14, wherein the at least one of either the cargo weight sensor, or number of vehicle weight sensors, is further configured to provide off-boarding weight data of cargo removed at differing time intervals; and
the controller is further configured, upon receiving the off-boarding weight data, re-optimize placement of remaining cargo.

16. The loading system of claim 15, wherein when the cargo placement is not able to be re-optimized, the controller is configured to send weight balance data to an electronic stability control system of the vehicle.

17. The loading system of claim 14, wherein the controller is further configured to aggregate loaded cargo with a baseline vehicle weight and send a signal of total vehicle weight.

18. A vehicular weight infrastructure, comprising:
a number of vehicle weight sensors configured to be located on a vehicle and provide real-time data of a sprung mass of the vehicle;
a controller configured to be located on the vehicle and, upon receiving the real-time data of the sprung mass of the vehicle and a base-line weight of an unloaded vehicle, provide upon query a total vehicle weight;
a transceiver configured to be located on the vehicle and in communication with the controller; and
a query device configured to be located outside of the vehicle to send a pinging signal near the vehicle, wherein the transceiver in conjunction with the controller receives the pining signal and broadcasts the total vehicle weight.

19. The vehicular weight infrastructure of claim 18, wherein the query device is located adjacent or overhead of a roadway a further comprises a proximity sensor to trigger the pinging signal.

20. The vehicular weight infrastructure of claim 19, further comprising a static scale in communication with the controller, the static scale configured to provide a base-line weight of an unloaded vehicle.
